(19) United States
(12) Patent Application Publication
(10) Pub. No.: US 2022/0353628 A1
(43) Pub. Date: Nov. 3, 2022

(54) SYSTEM AND METHOD FOR TRANSMITTING AT LEAST ONE MULTICHANNEL AUDIO MATRIX ACROSS A GLOBAL NETWORK

(71) Applicants: Ian KELLY, New Hope, PA (US); Peter GARY, Ewing, NJ (US)

(72) Inventors: Ian KELLY, New Hope, PA (US); Peter GARY, Ewing, NJ (US)

(21) Appl. No.: 17/736,032

(22) Filed: May 3, 2022

Related U.S. Application Data
(60) Provisional application No. 63/183,214, filed on May 3, 2021.

(51) Int. Cl. H04S 3/02; G10L 19/008; H04H 20/47

(52) U.S. Cl. CPC H04S 3/02; G10L 19/008; H04H 20/47; H04S 2400/01; H04S 2400/15

(57) ABSTRACT

A system and method for transmitting at least one multichannel audio matrix across a global network is shown and described. The method for transmitting at least one multichannel audio matrix across a global network begins by capturing audio from a production source. The captured audio is then converted from an analog format to a digital format. The digital audio may then be encoded using an audio codec. The audio is sent to a network and received at a second location. The second location uses a specialized computing device to ensure the audio is properly received. If the audio was encoded, it is now decoded. Once decoded if needed the audio is converted back to analog format. This will allow for the audio to be mixed on a mixing device.

### CROSS REFERENCE TO RELATED APPLICATIONS

This application claims the benefit of U.S. Provisional Application No. 63/183,214 filed on May 3, 2021. The above identified patent application is herein incorporated by reference in its entirety to provide continuity of disclosure.

### BACKGROUND OF THE INVENTION

The present invention relates to a system and method for transmitting at least one multichannel audio matrix across a global network. More particularly, the present invention provides a system for transmitting an audio matrix which may then be mixed, processed, and retransmitted by analog and digital mixing boards.

With the current COVID 2020-2021 government restrictions and requirements it is impossible to have large amounts of staff and equipment “locally” at performance venues. Gathering in large groups and working closely together became prohibited practices. Further, without the ability to produce shows, events, music, and other types of performances, remotely the events could not take place. These requirements and restrictions forced cancellations that eliminated over 12 million entertainment industry jobs overnight, from television to concerts to Broadway to sports to weddings; an entire professional industry had been nearly entirely eliminated.

It is well known that in recent standard practice audio would be captured and processed onsite at the venue location “locally” where the audio was created, either directly from an instrument or indirectly from a playback device. This was typically achieved by using large amounts of money, equipment, and staff to perform physical tasks onsite, “locally” at the venue location. These methods suffer high costs of equipment and labor.

Further, in a post pandemic world, there is always a need for high production value at a lower price point. For example, there are very limited options for high quality live broadcast mix, transmission and production from a concert or other venue. In workarounds some productions will skip the broadcast music mix stage and use the stereo feed from the public address (PA) system's “front-of-house” mixing console to feed to the live, on-air stream. This strategy can offer significant savings but at the cost of decreased production quality and value. In a live event, engineers use the venue's “front-of-house” system to mix sound in the concert hall or other performance space for the needs of the space and the live audience. The needs for broadcast are not the same. The feed from the public-address front-of-house mixing console will be limited to only the instruments that are patched through the front-of-house system and also will be affected by the inherent acoustics in the space to which the engineers might be adjusting the sound as is typically done when mixing for a live event using the front-of-house system. These limitations will affect the overall mix and feel of the feed based on a difference in monitoring environments, and ultimately the feed will not be a separate, discrete broadcast mix mixed with broadcast needs in mind.

An example of the differences between a front-of-house public address mix and a broadcast mix can be seen as follows. In this hypothetical scenario, the guitar player has an amp that is so loud in the room where the patrons are listening that the music mixing engineer operating the front-of-house public address (PA) system mixing board will not need to patch in or turn up the guitar in the public address system via the front-of-house mixing console because it will already be so loud in the room that the patrons listening in the room will hear it direct from the guitar amp, without coming through the PA system, i.e. without additional amplification. This scenario presents a problem if the front-of-house PA mix (which has no guitar) is fed to the broadcast feed. Again, the PA mix in this scenario would have no guitar because the guitar player's amp was so loud in the room that the engineer did not need to turn it up in the public address system for it to be heard in the room. A discrete mix needs to be created for broadcast, separate from the venue's PA system mix, to adjust for any differences between the needs of the live audience patron listening location (the performance venue) and the needs of the broadcast listeners' feed.

Therefore, there is a need for an improved audio production system and method for transmitting at least one multichannel audio matrix across a global network which can allow more events to take place for less cost overall, allowing more industry professionals to have jobs by creating savings, streamlining efficiencies, and creating safe operating scenarios. All of this can be done while improving audio quality.

Additionally, a system and method for transmitting at least one multichannel audio matrix across a global network creates unique workflow which allows one to process, route, and manage audio from a “local” source to a “remote” location serving the purposes of saving money by requiring less resources and manpower “locally” at the performance venue location for the purposes of allowing the user to process audio from a “remote” location to the highest quality broadcast and transmission industry standards. The system and method for transmitting at least one multichannel audio matrix across a global network allows producers of all kinds to broadcast higher quality productions at a lower price point from anywhere in the world.

This is achieved by creating a separate, discrete broadcast mix without the need for cost-prohibitive, expensive equipment and staff. This eliminates the problems of broadcasting the front-of-house mix and the decreased production quality derivative of a non-discrete, shared mix scenario.

There have been several attempts to solve the previously discussed problems, such as “Control Over IP.” Each of these attempts has come up short of producing the desired results, including transmission quality, real time speed and a workable price point. Control over IP allows the user to send small amounts of data and hardware-control messages by sharing the “local” interface, portal, terminal, screen, or gateway. This requires the audio to be processed “locally” and does not allow the user to access “remote” specialized equipment that would be unavailable due to proximity, such as but not limited to vintage analog audio pre-amps and unmovable, immobile, heavy audio, and/or fragile audio processing equipment and recording studios. The transmission of audio and processing “remotely” is not possible with Control-over-IP technology. Using Control-over-IP the audio is never transmitted the individual must control local mixing devices from a remote location. Further, the existing systems, devices and methods only allow for a “locally” sourced audio channels to be processed. In addition to being limited to processing only “locally” sourced audio on remote equipment, the problems encountered under current systems include delay in remote controller hardware tactical feedback, metering delay, and delay in performance timed cues, among other things.

Currently, other than the present invention there is nothing publicly available, whether theoretical or in use, which will solve the end-to-end problems discussed while at the same time keeping the audio matrix at broadcast quality.

### SUMMARY OF THE INVENTION

The present invention provides a system and method for transmitting at least one multichannel audio matrix across a global network wherein the same can be utilized for providing convenience for the user when producing audio, from any number of remote locations, for any number of purposes. The method for transmitting at least one multichannel audio matrix across a global network begins by capturing audio from a production source at a first location. The audio is then converted from an analog format to a digital format. Delivering the digital audio to a network. The digital audio is received at a second location via the network. The audio is then saved.

Another object of the method for transmitting at least one multichannel audio matrix across a global network is to use an audio codec to encode the digital format of the captured audio prior to delivering the audio to the network.

Another object of the method for transmitting at least one multichannel audio matrix across a global network is to decode the encoded digital audio once received at the second location.

Another object of the method for transmitting at least one multichannel audio matrix across a global network is to convert the digital audio to analog once received at the second location.

Another object of the method for transmitting at least one multichannel audio matrix across a global network is to send the digital audio to at least one mixing device.

Another object of the method for transmitting at least one multichannel audio matrix across a global network is to send the analog audio to at least one mixing device.

Another object of the method for transmitting at least one multichannel audio matrix across a global network is to record the mix.

Another object of the method for transmitting at least one multichannel audio matrix across a global network is to send the digital audio mix to the network.

Another object of the method for transmitting at least one multichannel audio matrix across a global network is to receive the digital mix at a desired location.

Another object of the method for transmitting at least one multichannel audio matrix across a global network is to have a receiving location which has a specialized computing device allowing the audio to be received.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of an embodiment of computing devices used for the system and method for transmitting at least one multichannel audio matrix across a global network.

FIG. 2 shows a diagram on an embodiment of the system for transmitting at least one multichannel audio matrix across a global network

FIG. 3 shows a chart of an embodiment for the system and method for transmitting at least one multichannel audio matrix across a global network.

FIG. 4 shows a flow chart of an embodiment of the method for transmitting at least one multichannel audio matrix across a global network.

### LIST OF REFERENCE NUMERALS

With regard to the reference numerals used, the following numbering is used throughout the drawings.
100 Node
101 Microphone
102 Conversion device
105 Computing device
105a Universal Serial Bus
105b Random-Access Memory
105c CPU
105d Network Interface
106 Network
107 Audio Codec
201 Software
202 Network
202a Routers/gateways
202c Virtual Private Network Cloud
203 Remote administrator
301 Audio Captured
302 Microphone/pre-amp
303 Digital converter
305 Transmission paths
306 Computer ingesting interface
307 Analog breakout
308 mixing consoles
309 mixing or blending
401 Capturing audio
402 Converting to digital format
403 Encoding
404 Sending audio to a network
405 Delivering audio
406 Decoding audio
407 Converting to analog
408 Sending audio to mixing device
409 Mixing Audio
410 Saving audio Converting mixed audio to
411 digital
412 Encoding audio
413 Sending mixed audio to network Receiving audio at desired
414 location

### DETAILED DESCRIPTION OF THE INVENTION

Reference is made herein to the attached drawings. Like reference numerals are used throughout the drawings to depict like or similar elements of the system and method for transmitting at least one multichannel audio matrix across a global network. For the purposes of presenting a brief and clear description of the present invention, a preferred embodiment will be discussed as used for the system and method for transmitting at least one multichannel audio matrix across a global network. The figures are intended for representative purposes only and should not be considered to be limiting in any respect.

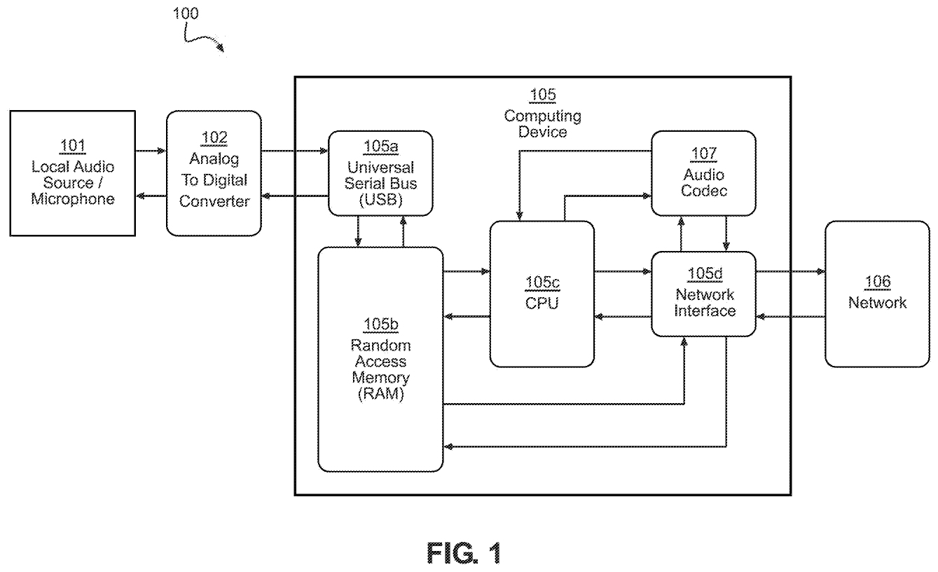

Referring now to FIG. 1, there is shown a diagram of an embodiment of a music conversion system. In one embodiment the music conversion system is comprised of several different electrical components creating a node 100. The node 100 allow for the capture of multichannel audio into the matrix to be transferred to a desired location. For the purposes of this disclosure, “multichannel” shall mean at least one channel but could be any multitude of channels as needed. The multichannel audio matrix is created by allowing for as many audio channels as needed to be connected to the single node 100. By allowing for all necessary channels to be connected to the same node 100 the need for excessive equipment and the cost associated with it is diminished. It is to be understood by one of ordinary skill in the art that electrical components will require a power source.

In one embodiment the local audio source is captured via at least one microphone 101. In other embodiments a different recording device is used to capture audio. However, no matter what is used, the device will capture audio from the source.

The captured audio will then be sent through a conversion device 102. The conversion device 102 will convert the audio from an analog format into a digital format. In one embodiment a Pulse-Code Modulation audio format is used. This will allow the audio to easily be imported into modern computing devices. The conversion device 102 is connected to a computing device 105.

In various embodiments different components may be included within the computing device. In the shown embodiment, the computing device 105 includes at least one universal serial bus 105a or USB connection. It is to be understood that while a USB is shown and described, any form of connection as used in connected hardware devices may be used, including, but not limited to, ethernet, HDMI, or wireless connections. The USB connection 105a is coupled to a random-access memory 105b or RAM. The RAM 105b is coupled to a CPU 105c.

The RAM 105b and the CPU 105c are both coupled to a network interface 105d. In one embodiment the network, interface 105c1 is a land line connection, or hard-wired connection. In another embodiment the network interface 105d is a wireless transceiver. In either embodiment the network interface is connected to a network 106.

In different embodiments the network 106 may be one of many different kinds of networks, including, for example, but not limited to, a LAN, a WAN, an internee router, an Internet Protocol (IP) network or a cellular network. While several examples use an IP network in order to describe the system, other networks could potentially be used. In the music industry a network typically refers to a local network. For this disclosure, the network or global network shall be used to describe a network that goes beyond a local network. This means that even if the audio is sent to a LAN, that LAN has a connection to a larger network. Here the purpose of any network used is such that the audio may be sent to a location different from where it is recorded. In some embodiments as described throughout, those different locations mean different cities around the world. In some instances, the network may be such that the audio is sent to different buildings located within the same city. In a further example, it is contemplated that using this system, audio may be sent to locations not on Earth but rather to orbiting satellites or space stations or even interplanetary or interstellar locations.

In some embodiments, the computing device 105 includes an audio codec 107. The audio codec 107 can be used to encode digital audio, In other embodiments the audio codec 107 will decode the digital audio. In yet another embodiment the audio codec is replaced with an endec. An endec will allow for audio to be encoded or decoded with a single device. In one embodiment the codec will allow for the computing device 105 to simultaneously encode and decode audio files. While it is shown as a physical device in the drawings of this application, it is to be understood that a codec 107 or endec may also include a software which is capable of encoding or decoding audio files. Software will allow for audio to be encoded or any number of computing devices without the need for a specialized piece of hardware.

In some embodiments, the referenced equipment may be used to encrypt the audio before sending. In other embodiments, specialized security software is employed to encrypt the audio. It is to be understood that similar devices or software may be used to decrypt the audio files. The encryption and decryption of the audio files will add an additional layer of security when sending the audio across networks.

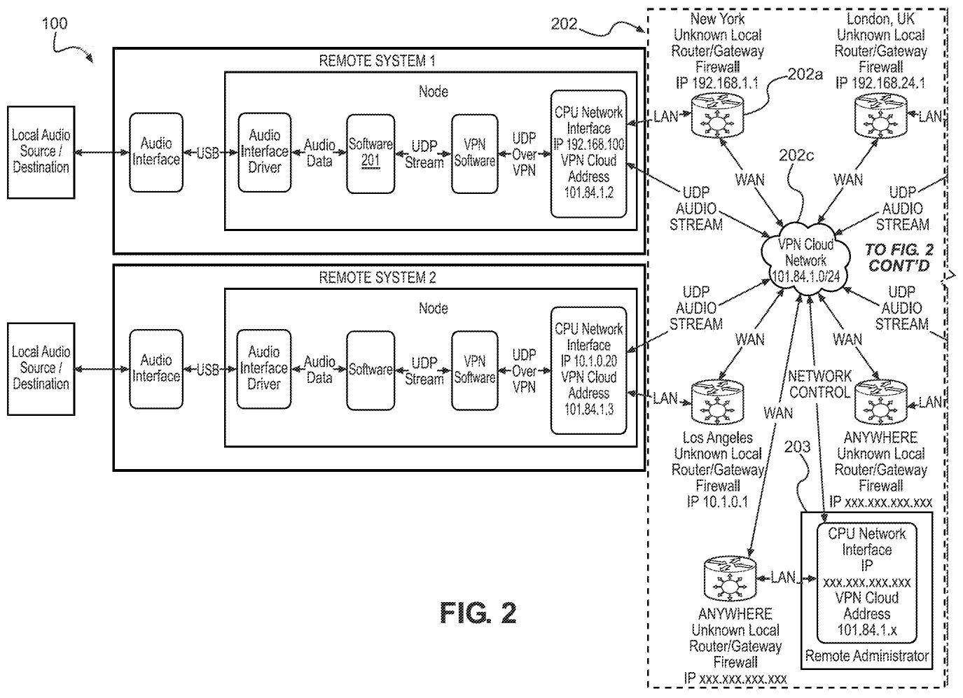

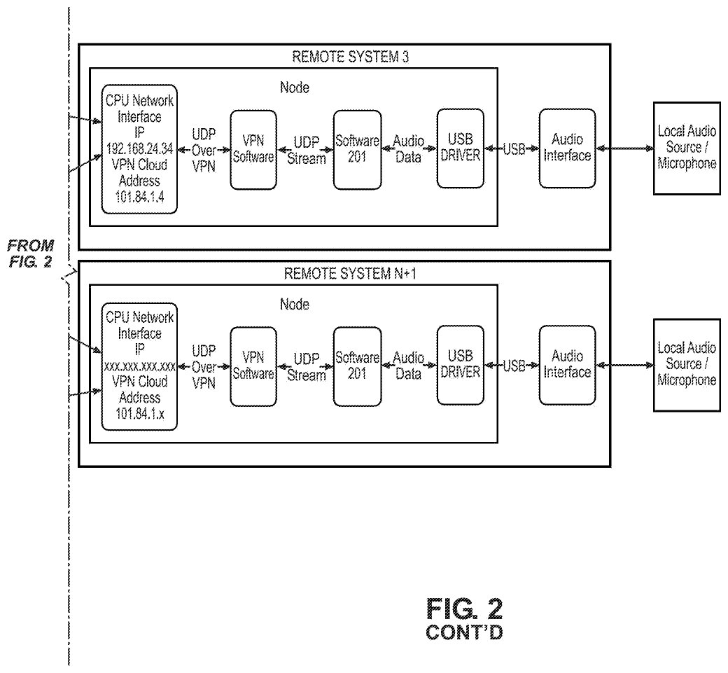

Referring now to FIG. 2, there is shown a diagram on an embodiment of the system for transmitting at least one multichannel audio matrix across a global network. It is to be understood that as discussed above there are many different types of networks. FIG. 2 shows a non-limiting example of one of many ways to achieve the described method. It is to be understood by one of ordinary skill in the art that many different types of networks may be used in order to achieve the described system and method. It is therefore to be understood that individual components may change, depending on the network, while still being part of the described method and system. In the shown embodiment, multiple locations transmit an audio matrix. Each location has a node 100. In the shown embodiment, each node is shown to further include software 201 loaded into the computer device 105. In different embodiments, different software may be used. The software 201 facilitates the transmission of the multichannel audio matrix. In one embodiment the software 201 facilitates the transmission of an encoded multichannel audio matrix.

In one embodiment, at least two nodes 201 are connected through an Internet protocol (IP) network 202. In one embodiment, the IP network is a multi-channel audio streaming-over-IP system. In one embodiment, the locations are in multiple global locations such as London, New York, and Los Angeles. Audio and video information can be passed from one location to another location for processing and production in real time with minimal latency and broadcast-quality results. Many different sound sources and production locations can come together to create a global audio or video matrix or multiple matrices acting and functioning in sync or discretely independent.

In order to facilitate the multiple sound sources, the IP network 202 includes multiple routers/gateways 202a. In one embodiment, each of these routers or gateways is protected via a firewall. Each of the routers or gateways 202a is coupled to Virtual Private Network (VPN) cloud 202c within the IP network 202. In one embodiment, all nodes 100 can be connected, to allow the users and administrators access to each local router for transmission purposes.

In one embodiment, the system includes an additional component, which for purposes of this disclosure will be referred to as a remote administrator 203, which will allow for quick and seamless connections from any network to the global system. In one embodiment, the remote administrator 203 will perform a secure handshake from the audio source location to the destination location without the need for specialized network protocols. This remote administrator 203 will further allow for the handshake to take place without the need for administrator/IT personnel to share IP addresses or security access codes. This will ensure a seamless and quick transmission.

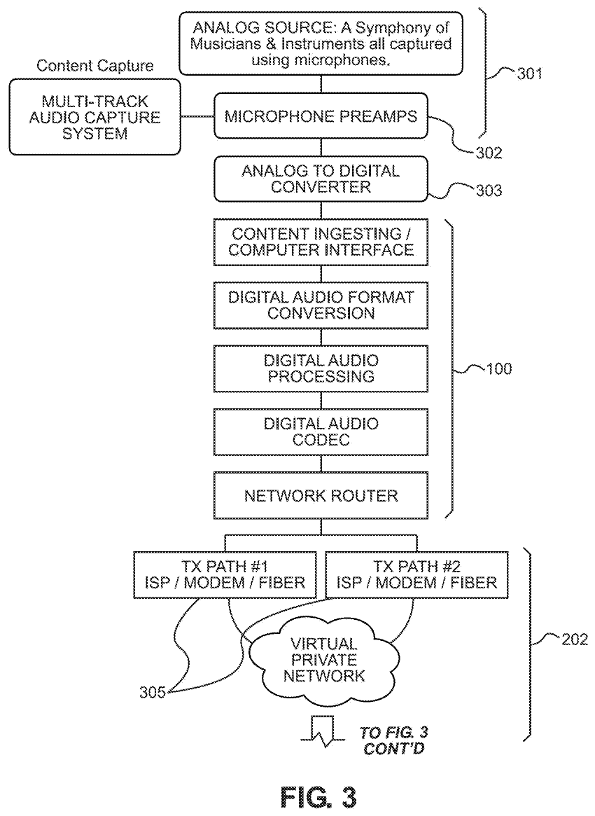

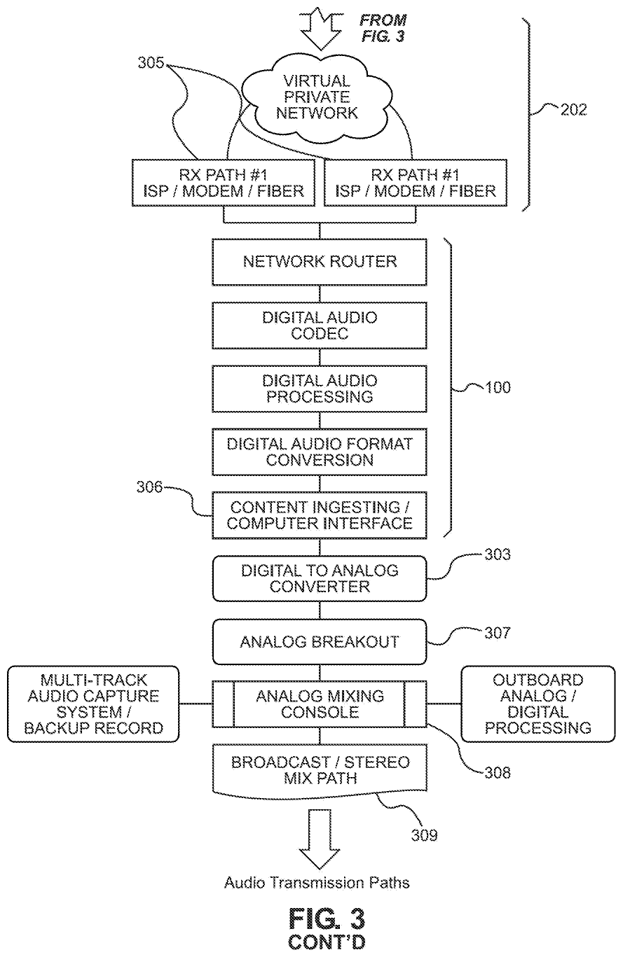

Referring now to FIG. 3, there is shown a chart of an embodiment for the system and method for transmitting at least one multichannel audio matrix across a global network. It is to be understood that, as discussed above, many different types of networks exist, and FIG. 3 shows a non-limiting example of one of many ways to achieve the described method. It is to be understood by one of ordinary skill in the art that many different types of networks may be used in order to achieve the described system and method. The system and method both start with a sound source. The sound source may be one or many voices or instruments or ambient sound of a location or event. Once the sound or sounds are emitted, they can be captured 301. In one non-limiting embodiment, the sounds are captured by an analog microphone or transducers. Any audio capture device now known or hereafter devised may be used to capture the sound from the sound source.

The captured audio signal is then amplified by a microphone pre-amp 302, as is typically done to boost the signal to the desired level for recording and/or processing. Once the audio signal is amplified, it is sent to an analog to digital converter 303. In one embodiment there might be multiple audio or sound sources streaming from multiple locations and captured in different locations respectively. It should be understood to one of ordinary skill in the art that converting the audio signal from analog to digital simplifies the sending of such audio across a global computer network.

In one embodiment, the digital audio may be ingested into a node 100 as described above. In one embodiment, the digital audio may require conversion to a desired different format. In another embodiment the digital audio may require processing such as compression and or other parameter adjustments that can be completed at this stage.

In one embodiment, a file-conversion process may be required to convert the digital audio file format or medium to a more desirable format or medium depending on the circumstances and or network requirements. Many different variables could affect the circumstances and flexibility of the files; in one embodiment, the size, manageability, fidelity and other parameters and specifications, or some combination of them, may dictate the circumstances in which conversion may be required for manipulating and moving digital audio files and formats through a network.

Similarly, the digital audio signal may require conversion to analog. In one embodiment, the digital audio signal, file, media, or sounds, or some combination of them, may be converted to multiple analog signal paths and channels relative to and in time-sync with one another. Once the conversion is complete, the analog signals may be passed through individual, discrete, shielded, multi-track audio break-out cables and hardware that meet industry standards and that compare favorably with commercial equipment of the highest technical standards, as is known in the art.

In one embodiment, the digital audio is encoded to prepare for sending to the network 202. Encoding may be done for the purpose of minimizing the size of the files for sending while retaining the broadcast audio quality.

The prepared and/or encoded audio is then transmitted to the network 202. In one embodiment, the prepared and/or encoded digital audio signal is sent across a network 202 that includes various redundancies such as primary, secondary, and transmission and/or network paths 305.

In one embodiment, there is at least one sending location and at least one receiving location; The location s may be in relatively close proximity relative to one another, such as a distance under 10ft or a distance much larger, such as New York to Beijing. As described above, the distance between locations for a transmission is limited only by the size of the network. In one embodiment, the audio is sent across a global network 202. In one embodiment the audio is transmitted from at least one remote location using multiple nodes. In this embodiment, the audio is received by a further node 100.

In one embodiment, once the audio is received it is sent to a computer-ingesting interface 306. The computer-ingesting interface 306 may make changes to the digital audio files similar to those changes described above. In one embodiment, the digital audio is then sent though a digital-to-analog converter 303. In one embodiment, an analog signal path or analog breakout 307 is created to send and receive effect and outboard processing equipment via discrete manageable, routable, recordable, and/or mixable channels. These signal paths can be used to enhance the sounds as is known in the art of recording studio technology, such as with rare and/or old, vintage-type equipment that cannot travel from the studios such as audio equipment that predates the digital age. These signal paths will send the audio to mixing consoles 308 or mixing devices. In some embodiments, these mixing consoles 308 have been permanently, non-movably installed at a recording studio in a remote location, yet the equipment and mixing consoles at that remote location may be used to enhance the tones and acoustic qualities of the captured sound because the system and method of the invention, according to this embodiment, send and receive the audio signal from the location(s) of its source(s) to the recording studio in the remote location. In one embodiment, the mixing console 308 may have been connected and built by master craftsmen and technicians that have since deceased, leaving no other working alternatives that achieve the same sound enhancement results. Without the system and method of the invention, such rare and special permanently installed equipment may be used only with audio signal that is present in close proximity to the permanently installed equipment, such as in that recording studio. There is no way to use such permanently installed equipment for remote-type virtual events and productions without the system and method of the invention.

In one embodiment, the audio is mixed and or blended 309 at the mixing console or mixing boards otherwise defined as the mixing device 308 to create a desired product. For the purpose of this disclosure a mixing device could be any device for mixing audio. In one embodiment the mixing device is a mixing board. In another embodiment the mixing device is a software which mixes audio. In one embodiment after mixing the audio signal can then be routed or sent to a recording device to capture the sounds for archival or backup purposes.

Many famous mixing studios and mixing boards comprise legacy equipment. Such legacy equipment is the product of tremendous work by sound engineers. Further, these legacy systems are created using analog systems and assembly language. These components are incredibly difficult to build and difficult or impossible to move. If moving were attempted, the legacy equipment may never function the same way again as just one broken circuit could destroy the mixer. The method and system of the invention allows audio captured and/or produced anywhere in the world to have access to a network to be mixed using such legacy systems. Further, the method and system enables audio from one part of the world to be combined with audio from any other part of the world, in real time and at broadcast quality.

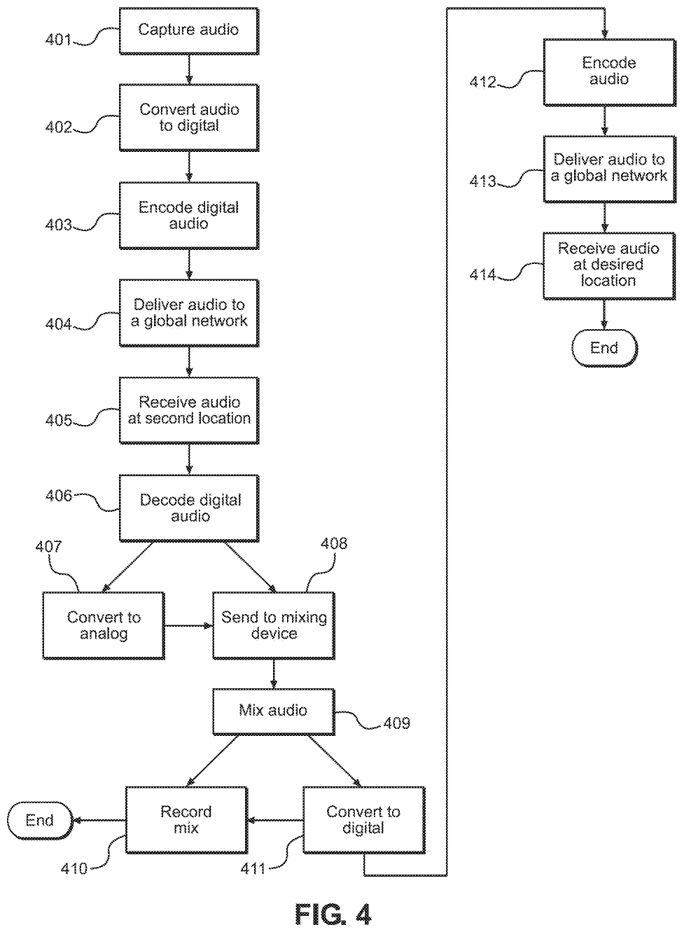

Referring now to FIG. 4, there is shown a flow chart of an embodiment of the method for transmitting at least one multichannel audio matrix across a global network. The method begins by capturing audio 401 from an audio source. In one embodiment the audio source is one or more instruments. In another embodiment the audio source comes from one or more microphones. In other embodiments other audio sources are used. In one embodiment there is more than one audio source. In yet another embodiment the audio sources are located in different locations.

The captured audio may be in a digital format already. More likely the audio is captured in an analog format. The next step is to convert the captured audio to a digital format 402. In some embodiments the digital formatted audio is of a size that can be directly sent via a network. In other embodiments the digital audio must first be encoded using a codec 403. The encoded digital audio is a smaller file and will this be sent more efficiently, thus it will not experience delays.

The digital audio is then sent to a network 404. Once sent to a network, the encoded audio is delivered to a desired location 405. In one embodiment the desired location 405 is a second location different from where the audio was captured. In the described system the audio may be sent from or sent to any number of different locations. While the disclosure is written in terms of definite locations such as a first location or a second location, it is possible for audio to be sent from a first location to an N+1 location. This means that any number of locations may be used in this system. It is further to be understood that audio may be delivered to a single location from N+1 locations. This means that audio may be sent from, for example, LA, London, NYC, and Philadelphia all to a location in Sydney, Australia using this system.

Once received at the desired location, the encoded digital audio is decoded using an audio codec 406. In one embodiment, the digital format is further converted to analog 407. This additional conversion to analog will allow the audio to be used on older, legacy mixing boards. After the audio is converted to the proper format according to the needs of the particular location and scenario, the audio is then sent to at least one mixing device 408.

At the mixing device the audio is then mixed 409. In some embodiments various audio streams are sent to the location and transferred to the mixing device. They all may be mixed together to create a single mix. In one embodiment these audio streams are sent to the mixing location from different physical locations. This means that a single mix may be created from audio captured from different locations around the world.

In some embodiments once the audio is mixed 409 it is then recorded or saved 410. In other embodiments the mixed audio needs to be sent out again. There could be various reasons for sending the mixed audio out again, for example the mix could be for a radio broadcast or a concert. In order to send the audio out, it may be converted, if necessary, to digital format 411. Once converted to digital format, it will need to further be encoded using a codec 412. In some embodiments, the digital format may be sufficient for sending the mixed audio without encoding.

Once converted to the proper format and encoded, as necessary, the mixed audio is sent to a network 413. Once sent to the network, the mixed audio is received by a desired location 414. In FIG. 4, the method ends there. However, in use the received audio may then be broadcast or played at the desired location for many various reasons.

It is to be understood by one of ordinary skill in the art that the described system will allow audio to be produced with the quality consistent with highest broadcast and production standards of the producers for the creative purposes of the specific circumstances and job. This result can be achieved with any digital or analog equipment, or any other device that compares favorably with commercial equipment of the highest technical standards.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for transmitting at least one multichannel audio matrix across a global network, comprising:
capturing audio from a production source at a first location;
converting the captured audio from an analog format to a digital format;
delivering the digital audio to a network;
receiving the digital audio at a second location via the network;
saving the audio.

2. The method for transmitting at least one multichannel audio matrix across a global network of claim 1, further comprising using an audio codec to encode the digital format of the captured audio prior to delivering the audio to the network; and
decoding the encoded digital audio once received at the second location.

3. The method for transmitting at least one multichannel audio matrix across a global network of claim 2 further comprising converting the digital audio to analog once received at the second location.

4. The method for transmitting at least one multichannel audio matrix across a global network of claim 3, further comprising sending the digital audio to at least one mixing device.

5. The method for transmitting at least one multichannel audio matrix across a global network of claim 1, further comprising sending the analog audio to at least one mixing device.

6. The method for transmitting at least one multichannel audio matrix across a global network of claim 5, further comprising recoding the mix.

7. The method for transmitting at least one multichannel audio matrix across a global network of claim 5, further comprising sending the digital audio mix to the network.

8. The method for transmitting at least one multichannel audio matrix across a global network of claim 5, further comprising receiving the digital mix at a desired location.

9. The method for transmitting at least one multichannel audio matrix across a global network of claim 1, wherein the receiving location has a specialized computing device allowing the audio to be received.

10. A method for transmitting at least one multichannel audio matrix across a global network, comprising:
capturing audio from a production source at a first location;
converting the captured audio from an analog format to a digital format;
encoding the digital using an audio codec;
sending the digital audio codec to a network;
receiving the digital audio at a second location via the network, wherein the receiving location has a specialized computing device allowing the audio to be received;
decoding the encoded digital audio;
converting the digital audio to an analog format.

11. The method for transmitting at least one multichannel audio matrix across a global network of claim 10 further comprising saving the audio.

12. The method for transmitting at least one multichannel audio matrix across a global network of claim 10, further comprising sending the analog audio to at least one mixing device.

13. The method for transmitting at least one multichannel audio matrix across a global network of claim 12, further comprising mixing the audio.

14. The method for transmitting at least one multichannel audio matrix across a global network of claim 13, further comprising converting the audio mix back to digital format.

15. The method for transmitting at least one multichannel audio matrix across a global network of claim 14, further comprising encoding the digital audio using an audio codec.

16. The method for transmitting at least one multichannel audio matrix across a global network of claim 15, further comprising sending the encoded audio to a desired location.

17. A method for transmitting at least one multichannel audio matrix across a global network, comprising:
capturing audio from a first production source;
converting the first captured audio from an analog format to a digital format;
encoding the first digital format audio;
sending the first encoded digital audio to a network;
receiving the first encoded digital audio at a third location via the network, wherein the receiving location has a specialized computing device allowing the first encoded digital audio to be received;
decoding the first encoded digital audio;
converting the first audio to an analog format;
capturing audio from a second production source;
converting the captured second audio from an analog format to a digital format;
encoding the second encoded digital audio;
sending the second encoded digital audio to a network;
receiving the second encoded digital audio at a third location via the network, wherein the receiving location has a specialized computing device allowing the audio to be received;
decoding the second encoded digital audio;
converting the second digital audio to an analog format.

18. The method for transmitting at least one multichannel audio matrix across a global network of claim 17 further comprising sending the first audio and the second audio to at least one mixing device.

19. The method for transmitting at least one multichannel audio matrix across a global network of claim 18, further comprising mixing the audio and creating an audio mix.

20. The method for transmitting at least one multichannel audio matrix across a global network of claim 19, further comprising converting the audio mix from analog to a digital format;
encoding the audio mix;
sending the encoded audio mix to a network;
sending the encoded audio mix to a desired location via the network.
